(19) United States
(12) Patent Application Publication
(10) Pub. No.: US 2025/0139065 A1
(43) Pub. Date: May 1, 2025

(54) SCHEMA-BASED OBJECT PROCESSING

(71) Applicant: Capital One Services, LLC, McLean, VA (US)

(72) Inventors: Jake Lowell BLITCH, Frisco, TX (US); Zhen HOU, Prosper, TX (US)

(21) Appl. No.: 18/498,838

(22) Filed: Oct. 31, 2023

(51) Int. Cl. G06F 16/21

(52) U.S. Cl. CPC G06F 16/212

(57) ABSTRACT

In some implementations, a system may obtain an object comprising a plurality of sub-objects. The system may identify a schema associated with serialization and deserialization of the object, the schema defining a plurality of mappings. Each mapping in the plurality of mappings may associate a respective set of sub-objects in the plurality of sub-objects with a file in a plurality of files. The system may process the object according to the schema to obtain the plurality of files. The system may provide an output including the plurality of files.

### BACKGROUND

Serialization may include converting an object, such as a programming language object, into a file (e.g., a series of bytes) that represents the object, including a state of the object. In general, serialization can be used to generate a file that facilitates transmission or storage of the programming language object (and the state of the programming language object). Deserialization is the reverse process-converting the file back to the programming language object in the state at the time of serialization. In general, the deserialization process recreates the programming language object to, for example, enable reading and modification of the programming language object or the state of the programming language object.

### SUMMARY

In some implementations, a system for schema-based object serialization includes one or more memories, and one or more processors, communicatively coupled to the one or more memories, configured to: obtain an object comprising a plurality of sub-objects; identify a schema associated with serialization and deserialization of the object, the schema defining a plurality of mappings, wherein each mapping in the plurality of mappings associates a respective set of sub-objects in the plurality of sub-objects with a file in a plurality of files; process the object according to the schema to obtain the plurality of files; and provide an output including the plurality of files.

In some implementations, a system for schema-based object processing includes one or more memories, and one or more processors, communicatively coupled to the one or more memories, configured to: obtain a plurality of files; identify a schema associated with serialization and deserialization of an object comprising a plurality of sub-objects, the schema defining a plurality of mappings, wherein each mapping in the plurality of mappings associates a respective set of sub-objects in the plurality of sub-objects with a file in the plurality of files; process one or more files in the plurality of files according to the schema to obtain one or more sets of sub-objects in the plurality of sub-objects; and provide an output including the one or more sets of sub-objects.

In some implementations, a method of schema-based object serialization and deserialization includes receiving, by a system, a file; identifying, by the system, a schema associated with serialization and deserialization of an object, the schema defining a mapping that associates a set of sub-objects in a plurality of sub-objects of an object with the file; processing, by the system, the file based on the schema to obtain the set of sub-objects; and providing, by the system, an output including the set of sub-objects.

### BRIEF DESCRIPTION OF THE DRAWINGS

FIGS. 1A-1C are diagrams of an example associated with schema-based object processing, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with selectively modifying a data stream based on content parameters, in accordance with some embodiments of the present disclosure.

FIG. 4 is a flowchart of an example process associated with schema-based object processing, in accordance with some embodiments of the present disclosure.

FIG. 5 is a flowchart of an example process associated with schema-based object processing, in accordance with some embodiments of the present disclosure.

### DETAILED DESCRIPTION

The following detailed description of example implementations refers to the accompanying drawings. The same references in different drawings may identify the same or similar elements.

An object, such as a programming language object, may need to be serialized to generate a file that represents the object, as well as a state of the object. In a particular example, a programming language object may comprise a model (e.g., a machine learning (ML) model) for which training has been performed. The programming language object may need to be serialized to enable the model and information associated with the model to be stored (e.g., for later use) or transmitted (e.g., over a network to another device). In general, the file resulting from serialization of the programming language object should be representative of the model itself and a state of the model after the training. The file can deserialized at a later time in order to, for example, enable further training of the model or use of the model (e.g., to make a prediction).

In practice, a user may need to store additional information associated with an object (in addition to the state of the object and the object itself) when serializing the object. For example, in the case of a programming language object including a model, a user may need to store metadata associated with the model (e.g., performance data associated with the model, hyperparameters for the model, input features for the model, or the like), one or more sub-models associated with the model (e.g., a third party library model), or the like. Notably, a modeling tool used to generate or train a model may in some cases provide its own serialization specifically designed for models generated or trained using the tool, meaning that the modeling tool may in some cases enable efficient serialization for models generated using the modeling tool. However, such a serialization capability may not be capable of serializing information associated with the model. Therefore, in practice, serialization of a programming language object including a model and information associated with the model is often performed using a (default or generic) serialization procedure that generates a single file.

However, a serialization that results in a single file that includes a model and other information associated with the model creates inefficiencies. For example, when an output of serialization is a single file that encompasses the model and other information associated with the model, the entirety of the file needs to be deserialized in order to obtain even a small item of information from the file. This wastes a significant amount of processing resources (e.g., processor power, processor time, or the like) and creates latency when, for example, only some portion of information encoded into the file needs to be loaded (rather than the entire model and all other information associated with the model). Further, serialization that results in a single file does not take advantage of serialization that may be available in a given modeling tool that could otherwise be used to serialize/deserialize a model, meaning that efficiency of serialization and deserialization may be reduced (e.g., when the serialization capability is designed specifically for the model). Additionally, serialization of objects is generally not standardized, meaning that serialization schemes used among objects of the same class (e.g., the same type, the same category, or the like) may not be consistent, which increases complexity with respect to serialization and deserialization of objects of the same class in a given system.

Some implementations described herein enable schema-based object processing. In some implementations, a processing system may obtain an object comprising a plurality of sub-objects. The processing system may identify a schema associated with serialization and deserialization of the object. Here, the schema may define a plurality of mappings, with each mapping associating a respective set of sub-objects in the plurality of sub-objects with a file in a plurality of files. The processing system may then process the object according to the schema to obtain the plurality of files, and provide an output including the plurality of files.

In some implementations, a processing system (e.g., another processing system) may obtain the plurality of files. The processing system may identify the schema (e.g., the schema according to which the plurality of files were generated). The processing system may then process one or more files in the plurality of files according to the schema to obtain one or more sets of sub-objects in the plurality of sub-objects. The processing system may then provide an output including the one or more sets of sub-objects.

In some implementations, the techniques and apparatuses for schema-based object processing described herein can improve efficiency with respect to object serialization and deserialization. For example, when an output of serialization is a plurality of files according to a schema, files can be selectively deserialized in order to obtain particular items of information from the plurality of files. This reduces processing resource consumption and latency when only some portion of information encoded into the plurality of files needs to be loaded. Further, schema-based object processing enables utilization of serialization that may be available in a given modeling tool, meaning that efficiency of serialization and deserialization may be increased. Additionally, serialization using the techniques and apparatuses for schema-based object processing enables standardization of serialization schemes that provides consistency with respect to serialization for objects of the same class, thereby reducing complexity with respect to serialization and deserialization of objects of the same class in a given system. Additional details are provided below.

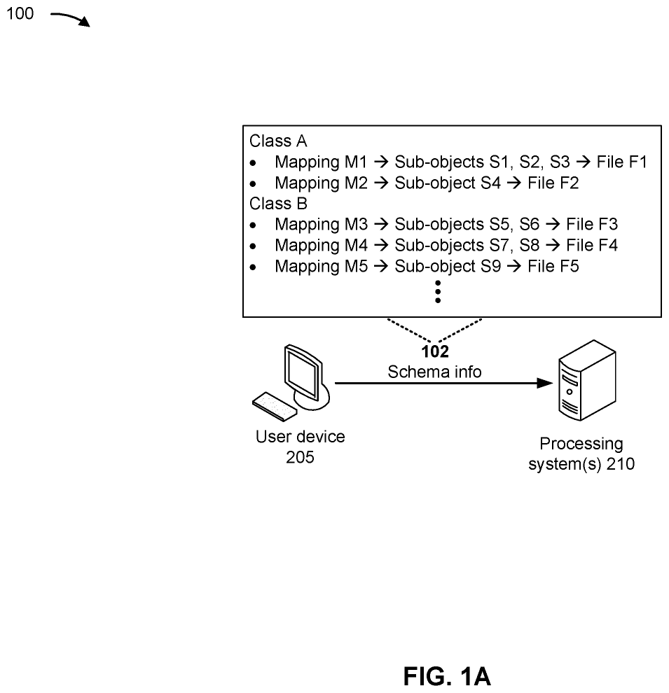

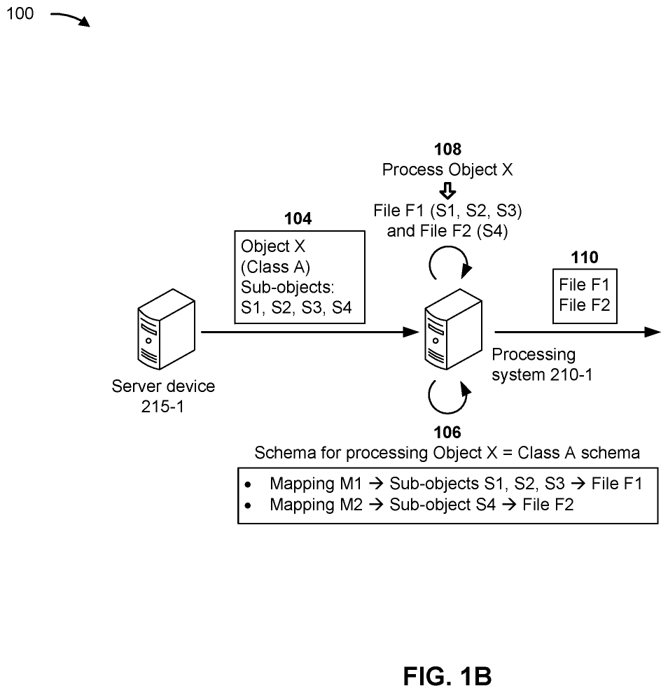

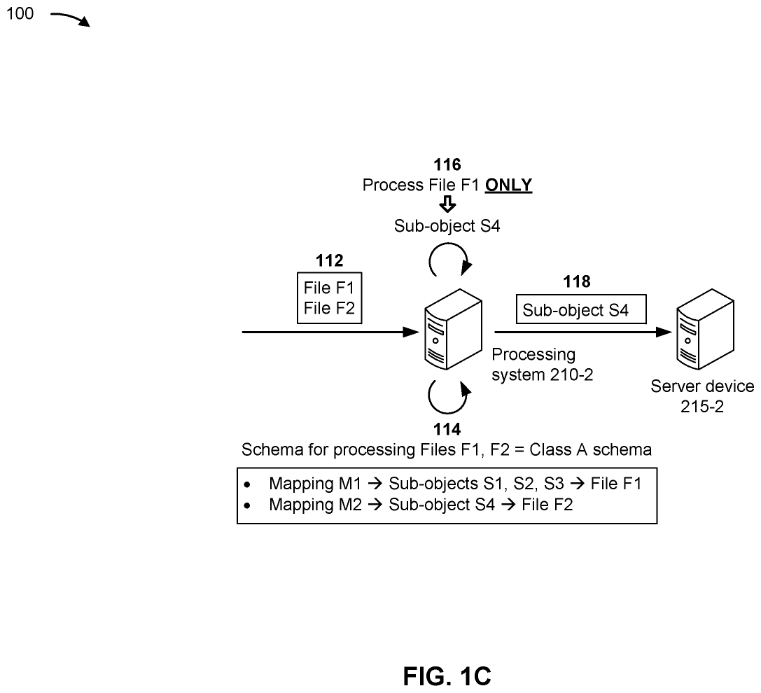

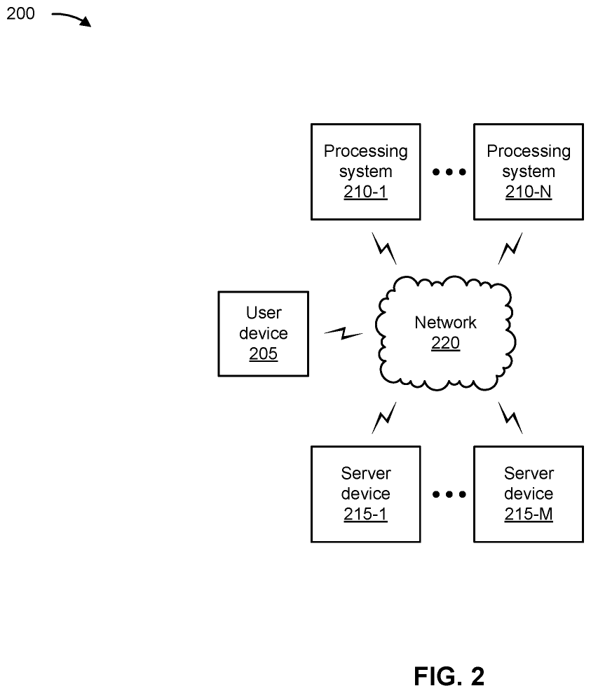

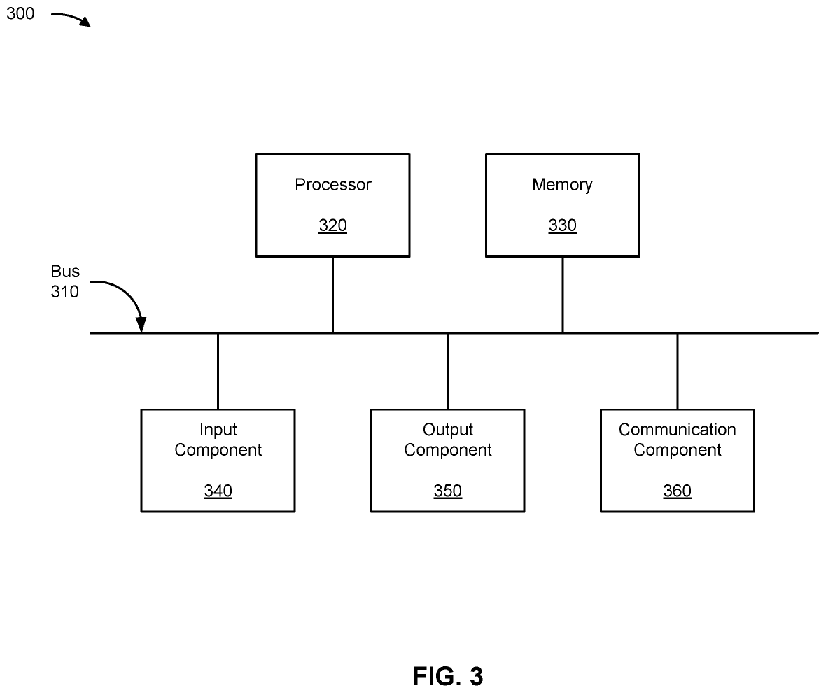

FIGS. 1A-1C are diagrams of an example 100 associated with schema-based object processing. As shown in FIGS. 1A-1C, example 100 includes a user device 205, one or more processing systems 210 (e.g., processing system 210-1 through 210-N(N≥1)), and one or more server devices 215 (e.g., server devices 215-1 through 215-M (M≥1)). These devices are described in more detail in connection with FIGS. 2 and 3.

As shown in FIG. 1A, the one or more processing systems 210 may obtain schema information (e.g., from one or more user devices 205). The schema information includes information that defines a manner in which an object of a particular class is to be serialized or deserialized (e.g., by a processing system 210). More particularly, the schema information may define a plurality of mappings for a class of object, where each mapping in the plurality of mappings associates one or more sub-objects of an object of the class with one or more files. In some implementations, each mapping identifies, indicates, or otherwise provides an encoder to be used in association with processing the one or more sub-objects associated with the mapping. That is, each mapping may provide an encoder that is to be used for encoding the one or more sub-objects associated with the mapping to generate a file. An encoder is a function that takes one or more sub-objects as input and provides a file as output. Similarly, in some implementations, each mapping identifies, indicates, or otherwise provides a decoder to be used in association with processing a file associated with the mapping. That is, each mapping may provide a decoder that is to be used for decoding the file associated with the mapping to obtain the one or more sub-objects. A decoder is a function that takes a file as input and provides one or more sub-objects as output. In some implementations, a mapping may be one-to-one with a single sub-object being encoded to and decoded from a single file. Additionally, or alternatively, a mapping may be one-to-multiple, with multiple sub-objects being encoded to and decoded from a single file. In some implementations, the mapping can utilize sequential indexing, key-based indexing, or the like. In some aspects, as indicated in FIG. 1A, the schema information may include multiple schemas, where each schema is associated with at least one class of object. A class of an object may be defined based on an object characteristic, such as a type or a category, among other examples.

In some implementations, the one or more processing systems 210 may receive the schema information from one or more user devices 205. In some implementations, the schema information is provided via user input (e.g., a user may define one or more schemas via user input to a user device 205). In the context of models (e.g., ML models), the schema information may include a schema that, for example, defines a plurality of mappings for a programming language object that comprises a model, items of metadata associated with the model (e.g., performance data associated with the model, hyperparameters for the model, input features for the model, or the like), one or more sub-models associated with the model, or the like, where each mapping associates one or more of the sub-objects with one or more files.

In one illustrative example, as shown in FIG. 1A, the schema information may include a schema for object class A. As shown, the schema for object class A defines a mapping M1 and a mapping M2. The mapping M1 associates sub-objects S1, S2, and S3 with a file F1. The mapping M2 associates a sub-object S4 with a file F2. With respect to serialization of an object of class A, the schema for object class A is to cause sub-objects S1, S2, and S3 to be processed (e.g., encoded) to generate a file F1 (according to the mapping M1) and to cause a sub-object S4 to be processed to generate a file F2 (according to the mapping M2). In this example, an output of serialization of an object of class A would include the file F1 (corresponding to sub-objects S1, S2, and S3) and the file F2 (corresponding to sub-object S4). With respect to deserialization of files associated with an object of class A, the schema for object class A is to cause the file F1 to be processed (e.g., decoded) to obtain the sub-objects S1, S2, and S3 (according to the mapping M1) and to cause the file F2 to be processed to obtain the sub-object S4 (according to the mapping M2).

In another illustrative example, as shown in FIG. 1A, the schema information may include a schema for object class B. As shown, the schema for object class B defines a mapping M3, a mapping M4, and a mapping M5. The mapping M3 associates sub-objects S5 and S6 with a file F3. The mapping M4 associates sub-objects S7 and S8 with a file F4. The mapping M5 associates a sub-object S9 with a file F5. With respect to serialization of an object of class B, the schema for object class B is to cause sub-objects S5 and S6 to be processed (e.g., encoded) to generate a file F3, to cause sub-objects S7 and S8 to be processed to generate a file F4, and to cause a sub-object S9 to be processed to generate a file F52. In this example, an output of serialization of an object of class B would include the file F3 (corresponding to sub-objects S5 and S6), the file F4 (corresponding to sub-objects S7 and S8), and the file F5 (corresponding to the sub-object S9). With respect to deserialization of files associated with an object of class B, the schema for object class B is to cause the file F3 to be processed (e.g., decoded) to obtain the sub-objects S5 and S6, to cause the file F4 to be processed to obtain the sub-objects S7 and S8, and to cause the file F5 to be processed to obtain the sub-object S9.

As shown in FIG. 1B at reference 104, a processing system 210-1 may obtain an object comprising a plurality of sub-objects. For example, as shown in FIG. 1B, the processing system 210-1 may receive, from a server device 215-1, an object X, with the object X including a plurality of sub-objects S1, S2, S3, and S4. As described above, the object may be a programming language object comprising a model, one or more items of metadata associated with the model, or one or more sub-models associated with the model, among other examples. In some implementations, the object may include information that identifies a class of the object. For example, as shown in FIG. 1B, the object X may include information that identifies the object X as a class A object (e.g., a programming language object that includes a particular type or category of model).

As shown at reference 106, the processing system 210-1 may identify a schema associated with serialization and deserialization of the object. In some implementations, the processing system 210-1 identifies the schema based on the class of the object. The processing system 210-1 may identify the class of the object based on, for example, information included in or received with the object (e.g., as described above with respect to reference 104) or by other means, such as based on user input that indicates the class of the object, or by analysis of the object (e.g., using a model configured to identify a class of an object based on the sub-objects included in the object). The processing system 210-1 may then identify the schema based on the schema information obtained by the processing system 210-1 (e.g., as described above with respect to reference 102). In FIG. 1B, the processing system 210-1 identifies the object X as a class A object and, therefore, identifies the schema associated with class A for serialization and deserialization of the object X.

As shown at reference 108, the processing system 210-1 may process the object according to the schema to obtain a plurality of files. For example, the processing system 210-1 may process the object based on the schema in order to generate a plurality of files. In some implementations, to process the object, the processing system 210-1 may encode a set of sub-objects, of the plurality of sub-objects, using an encoder associated with a mapping that is associated with the set of sub-objects. For example, each mapping may be associated with a set of sub-objects (e.g., a subset of the plurality of sub-objects included in the object) and a file, and may indicate an encoder and a decoder associated with the mapping. Here, the processing system 210-1 may encode the set of sub-objects using the indicated encoder to generate the file. In the example shown in FIG. 1B, the processing system 210-1 encodes the sub-objects S1, S2, and S3 using an encoder indicated by the mapping M1, a result of which is the file F1. Similarly, the processing system 210-1 encodes the sub-object S4 using an encoder indicated by the mapping M2, a result of which is the file F2. In this way, the processing system 210-1 may perform schema-based serialization of the object X to generate the file F1 and the file F2.

In some implementations, the schema may be designed so as to enable a serialization/deserialization capability associated with a sub-object (e.g., a model) to be utilized. For example, the schema may be configured so that a model can be encoded using a serialization capability (e.g., an encoder) of a modeling tool that is used in association with generating or training the model. In this way, efficiency of serialization and deserialization can be increased, thereby reducing processing resource consumption and improving overall efficiency (e.g., as compared to serializing all sub-objects to generate a single file in the manner described above).

As shown at reference 110, the processing system 210-1 may provide an output including the plurality of files. For example, the processing system 210-1 may output the file F1 and the file F2. In some implementations, the processing system 210-1 provides the plurality of files for storage to enable one or more of the files to be deserialized (e.g., by the processing system 210-1) at a later time. Additionally, or alternatively, the processing system 210 may provide the plurality of files to another device (e.g., via a network). For example, the processing system 210-1 may provide the plurality of files to a processing system 210-2 associated with a server device 215-2 (e.g., in association with providing access to the object X to the server device 215-2). In some implementations, the output of the processing system 210-1 may include information that identifies the schema used by the processing system 210-1 to process the object (e.g., so that the processing system 210-2 can identify the schema in association with deserializing the plurality of files, as described below).

As shown in FIG. 1C at reference 112, the processing system 210-2 (e.g., another processing system 210) may obtain the plurality of files. For example, the processing system 210-1 may provide, to the processing system 210-2 and via a network, the output including the plurality of files, as described. In some implementations, the output may include information that identifies the schema used by the processing system 210-1 in association with generating the plurality of files. In some implementations, the processing system 210-2 may obtain the plurality of files based on an indication that the object or one or more sub-objects of the object are to be used or accessed by the server device 215-2 (e.g., such that the server device 215-2 can access a model or information associated with the model that is included in a programming language object).

As shown at reference 114, the processing system 210-2 may identify the schema associated with serialization and deserialization of the object. In some implementations, the processing system 210-2 identifies the schema based on information that identifies the schema used to generate the plurality of files, as described above. Additionally, or alternatively, the processing system 210-2 may identify the schema based on the class of the object. The processing system 210-2 may identify the class of the object based on, for example, information included in or received with the plurality of files or by other means, such as based on user input that indicates the class of the object associated with the plurality of files, or by analysis of the plurality of files (e.g., using a model configured to identify a class of an object based on the plurality of files associated with the object). The processing system 210-2 may then identify the schema based on the schema information obtained by the processing system 210-2 (e.g., as described above with respect to reference 102). In FIG. 1C, the processing system 210-2 identifies the schema associated with class A as the schema to be used in association with deserialization of the plurality of files.

As shown at reference 116, the processing system 210-2 may process one or more files in the plurality of files according to the schema to obtain one or more sets of sub-objects in the plurality of sub-objects. For example, the processing system 210-2 may decode at least one file in the plurality of files to obtain the set of sub-objects associated with the file. In some implementations, to process the object, the processing system 210-2 may decode a file, of the plurality of files, using a decoder associated with a mapping that is associated with the file. For example, as described above, each mapping may be associated with a set of sub-objects (e.g., a subset of the plurality of sub-objects included in the object) and a file, and may indicate an encoder and a decoder associated with the mapping. Here, the processing system 210-1 may decode the file using the indicated decoder to obtain the set of sub-objects.

In the example shown in FIG. 1C, the processing system 210-1 decodes the file F2 using a decoder indicated by the mapping M2, a result of which is the sub-object S4. Notably, the processing system 210-2 in this example does not process all of the files in the plurality of files. Rather, the processing system 210-2 processes the file F2 only (i.e., the processing system 210-2 does not decode the file F1 and, therefore, does not obtain the sub-objects S1, S2, and S3). In this way, the schema-based object processing enables selective processing that can reduce resource consumption and latency. For example, the server device 215-2 may need only the sub-object S4 to be loaded (e.g., the server device 215-2 may need only metadata associated with a model, rather than the model itself). Here, the processing system 210-2 may determine, based on the schema, that only the file F2 needs to be processed (rather than both files F1 and F2). As a result, resource consumption and latency associated with loading the sub-object S4 to the server device 215-2 is reduced (e.g., as compared to decoding all of the files). In some implementations, this partial loading technique enables lazy or selective loading such that only some particular sub-object(s) are loaded. For example, one item of metadata may be loaded without the overhead of reading in all other information associated with the object. As another example, a specific model may be loaded without loading in other models or their associated metadata. In some implementations, the processing system 210-2 may obtain loading information that indicates one or more particular files of the one or more files, and may process the file based on the loading information (e.g., such that only the one or more particular files are processed by the processing system 210-2). In some implementations, the processing system 210-2 may obtain the loading information via user input (e.g., a user may select which files of the plurality of files are to be processed).

In some implementations, the processing system 210-2 may process each file in the plurality of files (e.g., such that the processing system 210-2 obtains all sub-objects associated with the object). In some implementations, the processing system 210-2 may be configured to process all files in the plurality of files by default (e.g., the processing system 210-2 may decode all of the files unless the processing system 210-2 receives loading information indicating otherwise).

As shown at reference 118, the processing system 210-2 may provide an output including the one or more sets of sub-objects. For example, the processing system 210-2 may output the one or more sets of sub-objects such that the one or more sets of sub-objects can be loaded to another device (e.g., a server device 215). In a scenario in which the processing system 210-2 processes all files in the plurality of files, the processing system 210-2 may output the plurality of sub-objects (e.g., the object in its entirety). In a scenario in which the processing system 210-2 processes a subset of the plurality of files, the processing system 210-2 may output one or more sets of sub-objects obtained as a result of processing the subset of files. For example, as shown in FIG. 1C, the processing system 210-2 outputs the sub-object S4 to enable the sub-object S4 to be loaded on the server device 215-2.

As indicated above, FIGS. 1A-1C are provided as an example. Other examples may differ from what is described with regard to FIGS. 1A-1C.

FIG. 2 is a diagram of an example environment 200 in which systems and/or methods described herein may be implemented. As shown in FIG. 2, environment 200 may include a user device 205, one or more processing systems 210-1 through 210-N(N≥1), one or more server devices 215-1 through 215-M (M≥1), and a network 220. Devices of environment 200 may interconnect via wired connections, wireless connections, or a combination of wired and wireless connections.

The user device 205 may include one or more devices capable of receiving, generating, storing, processing, and/or providing information associated with schema-based object processing, as described elsewhere herein. The user device 205 may include a communication device and/or a computing device. For example, the user device 205 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The processing system 210 may include one or more devices capable of generating, storing, processing, providing, and/or routing information associated with schema-based object processing, as described elsewhere herein. The processing system 210 may include a communication device and/or a computing device. For example, the processing system 210 may include a server, such as an application server, a client server, a web server, a database server, a host server, a proxy server, a virtual server (e.g., executing on computing hardware), or a server in a cloud computing system. In some implementations, the processing system 210 may include computing hardware used in a cloud computing environment.

The server device 215 may include one or more devices capable of receiving, generating, storing, processing, providing, and/or routing information associated with schema-based object processing, as described elsewhere herein. The server device 215 may include a communication device and/or a computing device. For example, the server device 215 may include a server, such as an application server, a client server, a web server, a database server, a host server, a proxy server, a virtual server (e.g., executing on computing hardware), or a server in a cloud computing system. In some implementations, the server device 215 may include computing hardware used in a cloud computing environment.

The network 220 may include one or more wired and/or wireless networks. For example, the network 220 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 220 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with selectively modifying a data stream based on content parameters. The device 300 may correspond to the user device 205, the processing system 210, and/or the server device 215. In some implementations, the user device 205, the processing system 210, and/or the server device 215 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

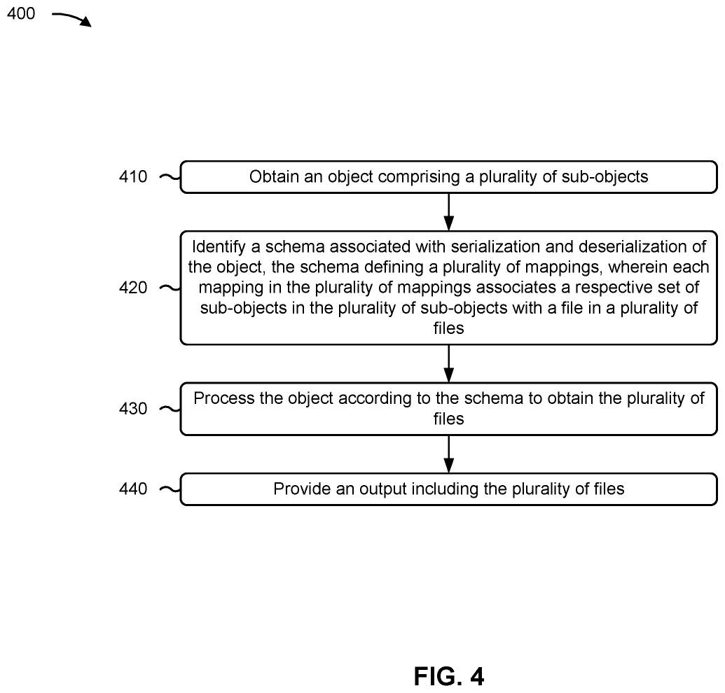

FIG. 4 is a flowchart of an example process 400 associated with schema-based object processing. In some implementations, one or more process blocks of FIG. 4 may be performed by the processing system 210. In some implementations, one or more process blocks of FIG. 4 may be performed by another device or a group of devices separate from or including the processing system 210, such as the user device 205 and/or the server device 215. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining an object comprising a plurality of sub-objects (block 410). For example, the processing system 210 (e.g., using processor 320 and/or memory 330) may obtain an object comprising a plurality of sub-objects, as described above in connection with reference 104 of FIG. 1B. As an example, the processing system 210-1 may obtain an object X (e.g., a programming language object) including a plurality of sub-objects S1 through S4 (e.g., a model, metadata associated with the model, one or more sub-models associated with the model, or the like).

As further shown in FIG. 4, process 400 may include identifying a schema associated with serialization and deserialization of the object, the schema defining a plurality of mappings, wherein each mapping in the plurality of mappings associates a respective set of sub-objects in the plurality of sub-objects with a file in a plurality of files (block 420). For example, the processing system 210 (e.g., using processor 320 and/or memory 330) may identify a schema associated with serialization and deserialization of the object, the schema defining a plurality of mappings, wherein each mapping in the plurality of mappings associates a respective set of sub-objects in the plurality of sub-objects with a file in a plurality of files, as described above in connection with reference 106 of FIG. 1B. As an example, the processing system 210-1 may identify a class A schema associated with serialization and deserialization of the object X, with the schema defining the mappings M1 and M2, where the mapping M1 associates the sub-objects S1, S2, and S3 with a file F1 and the mapping M2 associates the sub-object S4 with a file F2.

As further shown in FIG. 4, process 400 may include processing the object according to the schema to obtain the plurality of files (block 430). For example, the processing system 210 (e.g., using processor 320 and/or memory 330) may process the object according to the schema to obtain the plurality of files, as described above in connection with reference 108 of FIG. 1B. As an example, the processing system 210-1 may process the object X according to the class A schema to obtain the files F1 and F2.

As further shown in FIG. 4, process 400 may include providing an output including the plurality of files (block 440). For example, the processing system 210 (e.g., using processor 320 and/or memory 330) may provide an output including the plurality of files, as described above in connection with reference 110 of FIG. 1B. As an example, the processing system 210-1 may provide an output including the files F1 and F2.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1C. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

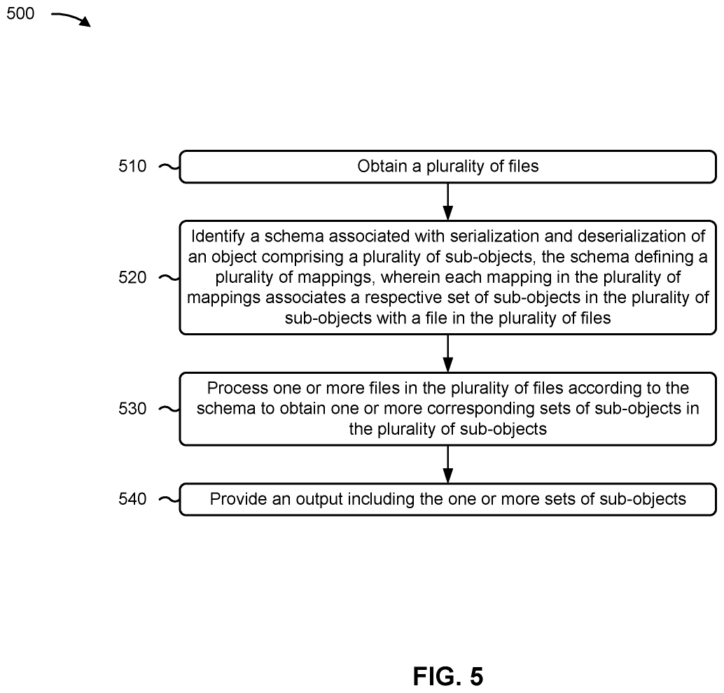

FIG. 5 is a flowchart of an example process 500 associated with schema-based object processing. In some implementations, one or more process blocks of FIG. 5 may be performed by the processing system 210. In some implementations, one or more process blocks of FIG. 5 may be performed by another device or a group of devices separate from or including the processing system 210, such as the user device 205 and/or the server device 215. Additionally, or alternatively, one or more process blocks of FIG. 5 may be performed by one or more components of the device 300, such as processor 320, memory 330, input component 340, output component 350, and/or communication component 360.

As shown in FIG. 5, process 500 may include obtaining a plurality of files (block 510). For example, the processing system 210 (e.g., using processor 320 and/or memory 330) may obtain a plurality of files, as described above in connection with reference 112 of FIG. 1C. As an example, a processing system 210-2 may obtain a file F1 and a file F2.

As further shown in FIG. 5, process 500 may include identifying a schema associated with serialization and deserialization of an object comprising a plurality of sub-objects, the schema defining a plurality of mappings, wherein each mapping in the plurality of mappings associates a respective set of sub-objects in the plurality of sub-objects with a file in the plurality of files (block 520). For example, the processing system 210 (e.g., using processor 320 and/or memory 330) may identify a schema associated with serialization and deserialization of an object comprising a plurality of sub-objects, the schema defining a plurality of mappings, wherein each mapping in the plurality of mappings associates a respective set of sub-objects in the plurality of sub-objects with a file in the plurality of files, as described above in connection with reference 114 of FIG. 1C. As an example, the processing system 210-2 may identify a class A schema associated with serialization and deserialization of an object X (e.g., a programming language object) including a plurality of sub-objects S1 through S4 (e.g., a model, metadata associated with the model, one or more sub-models associated with the model, or the like).

As further shown in FIG. 5, process 500 may include processing one or more files in the plurality of files according to the schema to obtain one or more sets of sub-objects in the plurality of sub-objects (block 530). For example, the processing system 210 (e.g., using processor 320 and/or memory 330) may process one or more files in the plurality of files according to the schema to obtain one or more sets of sub-objects in the plurality of sub-objects, as described above in connection with reference 116 of FIG. 1C. As an example, the processing system 210-1 may process the file F2 according to the class A schema to obtain the sub-object S4.

As further shown in FIG. 5, process 500 may include providing an output including the one or more sets of sub-objects (block 540). For example, the processing system 210 (e.g., using processor 320 and/or memory 330) may provide an output including the one or more sets of sub-objects, as described above in connection with reference 118 of FIG. 1C. As an example, the processing system 210-2 may provide an output including the sub-object S4.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1C. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for schema-based object serialization, the system comprising:
one or more memories; and
one or more processors, communicatively coupled to the one or more memories, configured to:
obtain an object comprising a plurality of sub-objects;
identify a schema associated with serialization and deserialization of the object, the schema defining a plurality of mappings,
wherein each mapping in the plurality of mappings associates a respective set of sub-objects in the plurality of sub-objects with a file in a plurality of files;
process the object according to the schema to obtain the plurality of files; and
provide an output including the plurality of files.

2. The system of claim 1, wherein a sub-object in the plurality of sub-objects includes a model associated with the object, an item of metadata associated with the model, or a sub-model associated with the model.

3. The system of claim 1, wherein the one or more processors are configured to identify the schema based on information that identifies a class associated with the object.

4. The system of claim 1, wherein the one or more processors, to process the object, are configured to encode a set of sub-objects, of the plurality of sub-objects, using an encoder associated with a mapping, of the plurality of mappings, that is associated with the set of sub-objects.

5. A system for schema-based object processing, the system comprising:
one or more memories; and
one or more processors, communicatively coupled to the one or more memories, configured to:
obtain a plurality of files;
identify a schema associated with serialization and deserialization of an object comprising a plurality of sub-objects, the schema defining a plurality of mappings,
wherein each mapping in the plurality of mappings associates a respective set of sub-objects in the plurality of sub-objects with a file in the plurality of files;
process one or more files in the plurality of files according to the schema to obtain one or more sets of sub-objects in the plurality of sub-objects; and
provide an output including the one or more sets of sub-objects.

6. The system of claim 5, wherein the one or more processors are configured to identify the schema based on information that identifies a class associated with the object.

7. The system of claim 5, wherein a sub-object in the one or more sets of sub-objects includes a model associated with the object, an item of metadata associated with the model, or a sub-model associated with the model.

8. The system of claim 5, wherein the one or more processors, to process the one or more files, are configured to decode a file, of the one or more files, using a decoder associated with a mapping, of the plurality of mappings, that associates a set of sub-objects with the file.

9. The system of claim 5, wherein the one or more processors are further configured to:
obtain loading information that indicates a file of the one or more files; and
process the file based on the loading information.

10. The system of claim 9, wherein the loading information is obtained via user input.

11. The system of claim 5, wherein the one or more files do not include all files in the plurality of files and the output does not include all sub-objects in the plurality of sub-objects.

12. The system of claim 5, wherein the one or more files include all files in the plurality of files and the output is the object including the plurality of sub-objects.

13. A method of schema-based object serialization and deserialization, the method comprising:
receiving, by a system, a file;
identifying, by the system, a schema associated with serialization and deserialization of an object, the schema defining a mapping that associates a set of sub-objects in a plurality of sub-objects of an object with the file;
processing, by the system, the file based on the schema to obtain the set of sub-objects; and
providing, by the system, an output including the set of sub-objects.

14. The method of claim 13, wherein the schema is identified based on information that identifies a class associated with the object.

15. The method of claim 13, wherein a sub-object in the set of sub-objects includes a model associated with the object, an item of metadata associated with the model, or a sub-model associated with the model.

16. The method of claim 13, wherein processing the file comprises decoding the file using a decoder associated with the mapping.

17. The method of claim 13, wherein further comprising:
obtaining loading information that indicates the file is to be decoded; and
processing the file based on the loading information.

18. The method of claim 17, wherein the loading information is obtained via user input.

19. The method of claim 13, wherein the file is one file in a plurality of files associated with the object and the output does not include all sub-objects in the plurality of sub-objects.

20. The method of claim 13, wherein the output is the object including the plurality of sub-objects.
